(19) United States
(12) Patent Application Publication
(10) Pub. No.: US 2020/0015047 A1
(43) Pub. Date: Jan. 9, 2020

(54) WIFI MULTI-BAND FINGERPRINT-BASED INDOOR POSITIONING

(71) Applicant: Ranplan Wireless Network Design Limited, Cambridge Cambridgeshire (GB)

(72) Inventors: Hui SONG, Cambridge (GB); Jiming CHEN, Cambridge (GB); Zhihua LAI, Cambridge (GB); Jie ZHANG, Cambridge (GB)

(21) Appl. No.: 16/494,727

(22) PCT Filed: Mar. 15, 2018
(86) PCT No.: PCT/GB2018/050675

§ 371 Date: Sep. 16, 2019

(30) Foreign Application Priority Data
Mar. 16, 2017 (GB) 1704216.9

(51) Int. Cl. H04W 4/33; H04W 4/029; H04W 24/10; H04W 4/02; G01S 5/02

(52) U.S. Cl. CPC H04W 4/33; H04W 4/029; G01S 5/0252; H04W 4/026; H04W 24/10

(57) ABSTRACT

A method for determining the position of a mobile or asset in an indoor location in a radio frequency system, the method comprising: a) generating a Wi-Fi multi-band fingerprint database using at least one multi-band Wi-Fi access point configured to simultaneously transmit multiple frequency band wireless signals; b) selecting a most probable frequency band having the highest probability function for a target location of the mobile or asset given one or more measured signals; c) selecting one or more fingerprints from the Wi-Fi multi-band fingerprint database in dependence on the selected frequency band and selecting a measured signal that is needed to determine the location in dependence on the said most probable frequency band for each Wi-Fi access point; and d) comparing the selected measured signal and the selected one or more fingerprints to determine the location of the measured signal in dependence on a location estimation algorithm.

### FIELD OF THE INVENTION

This invention relates to a method for positioning indoor location in a radio frequency (RF) transmission and receive system. The present invention generally relates to wireless communications and more particularly relates to indoor positioning method based on fingerprint WiFi system with multi-band diversity combining.

### TECHNICAL BACKGROUND

With the rapid development of smart phones and wireless networks, outdoor location-based services have been widely used. But, because most of the time people live and work are concentrated in the building, shopping malls, restaurants and other indoor environment, the demand of indoor location-based services are increasingly growing. How to accurately determine the indoor location is the foundation and key of location-based services. Currently, indoor location, according to the signal types, has WiFi, Bluetooth, ultra-wide band (UWB), built-in motion sensors and other terminal-based positioning method. WiFi networks are more popular, and WiFi signal is more stable and easy to obtain, therefore Wi-Fi network provides adequate infrastructure for the indoor positioning technology, but also reduces the cost to achieve the desired positioning. WiFi positioning system is hence cost-effective without the need of extra infrastructure investment.

Among the many indoor positioning technologies, location-based fingerprint indoor positioning technology can make ideal positioning at a lower cost premises. Therefore, based on the location of the fingerprint WiFi indoor positioning technology is imperative, which is usually conducted in two phases: an offline phase (survey) followed by an online phase (query). In the offline phase, a site survey is conducted to collect the vectors of received signal strength (RSS) of all the detected WiFi signals from different access points (APs) at many reference points (RPs) of known locations. Hence, each RP is represented by its fingerprint. All the RSS vectors form the fingerprints of the site and are stored at a database for online query. In the online phase, a user (or target) samples or measures an RSS vector at its positions and compares the received target vector with the stored fingerprints. The target position is estimated based on the most similar ‘neighbours’, the set of RPs whose fingerprints closely match the target's RSS.

Current fingerprint-based positioning method utilizes only one frequency band of RSS signal, because multi-path component and obstacles in the building make RSS become fluctuated and unpredictable, the achievable accuracy from utilizing the instantaneous measured RSS to estimate location are very low. The achievable accuracy has been reported in the range of 2-10 meters.

### SUMMARY OF THE INVENTION

According to a first aspect of the present invention there is provided a method for determining the position of a mobile or asset in an indoor location in a radio frequency transmission and receive system, the method comprising: a) generating a Wi-Fi multi-band fingerprint database using at least one multi-band Wi-Fi access point configured to simultaneously transmit multiple frequency band wireless signals; b) selecting, from the multiple frequency band wireless signals transmitted by each Wi-Fi access point, a most probable frequency band having the highest probability function for a target location of the mobile or asset given one or more measured signals; c) selecting one or more fingerprints from the Wi-Fi multi-band fingerprint database in dependence on the selected frequency band and selecting a measured signal that is needed to determine the location in dependence on the said most probable frequency band for each Wi-Fi access point; and d) comparing the selected measured signal and the selected one or more fingerprints to determine the location of the measured signal in dependence on a location estimation algorithm.

Generating the Wi-Fi multi-band fingerprint database may comprise: a) defining a plurality of reference points having known locations in an indoor area; b) getting a plurality of received signal strengths for a plurality of detected Wi-Fi signals from a plurality of access points at the respective defined reference points; and c) storing the plurality of received signal strengths and corresponding location information of the respective access points at the respective reference points as the Wi-Fi multi-band fingerprint database.

Getting the plurality of received signal strengths may comprise: measuring the plurality of received signal strengths for the plurality of detected Wi-Fi signals from the plurality of access points at the respective defined reference points.

Getting the plurality of received signal strengths may comprise: modelling an indoor scenario and network; and simulating the plurality of received signal strengths from the plurality of access points at the respective defined reference points.

The Wi-Fi multi-band fingerprint database may further comprise location information, average received signal strength and variance of received signal strength, a fingerprint at /th reference point being represented by

$${( x , y , z , o )}_{l} , {[ \begin{matrix}{\overline{RSS}}_{1 , 1} , & {\overline{RSS}}_{1 , 2} , & … , & {\overline{RSS}}_{1 , B} \\ {\overline{RSS}}_{2 , 1} , & {\overline{RSS}}_{2 , 2} , & … , & {\overline{RSS}}_{2 , B} \\ ⋮ & ⋮ & ⋱ & ⋮ \\ {\overline{RSS}}_{K , 1} , & {\overline{RSS}}_{K , 2} , & … , & {\overline{RSS}}_{K , B}\end{matrix} ]}_{l} , \\ {[ \begin{matrix}{σ}_{1 , 1} , & {σ}_{1 , 2} , & … , & {σ}_{1 , B} \\ {σ}_{2 , 1} , & {σ}_{2 , 2} , & … , & {σ}_{2 , B} \\ ⋮ & ⋮ & ⋱ & ⋮ \\ {σ}_{K , 1} , & {σ}_{K , 2} , & … , & {σ}_{K , B}\end{matrix} ]}_{l}$$

where x, y, and z are three-dimension location coordinates at an/th reference point, and o is an orientation with East, South, West, and North at the /th reference point, R̅S̅S̅_{i,b} is an average received signal strength from an ith access point and a bth band at the /th reference point, and a_{i,b} is a variance of received signal strength from the ith access point and a bth band at the ith reference point.

The said average received signal strength may be the mean value of the plurality of received signal strengths per access point per band at one reference point during a sampling period, and the variance is the variance value of all received signal strengths per access point per band at one reference point during a sampling period.

The said most probable frequency band may be selected by a multi-band diversity combining method which comprises: a) getting a probability function, P(s_{i,b}|l), that a signal s_{i,b} is received at a given location/in dependence on the said multi-band fingerprint database, wherein s_{i,b} is the measured received signal strengths from an ith Wi-Fi access point and a bth frequency band at the given location l; b) calculating the probability function P(l|s_{i,b}) at the target location/based on the given signals s_{i,b}; and c) finding the frequency band with the highest probability function,

$$arg {max}_{b} P ( l \vert {s}_{i , b} ) ,$$

for each access point.

The probability function P(s_{i,b}|l) may be calculated by: a) surveying received signal strength multiple times at each of at least one survey location, and getting a statistically significant number of occurrences of each possible signal; and b) approximating the probability function P(s_{i,b}|l) by maximum likelihood methods.

The said maximum likelihood may be modelled by parametric distributions.

Selecting the measured signal may further comprise: a) measuring multi-band received signal strengths at the target location from each access point; and b) reporting the multi-band measured received signal strengths of each access point to a server.

The reported multi-band measured received signal strengths for each access point may be represented by

$$( {x}^{′} , {y}^{′} , {z}^{′} , o ) , [ \begin{matrix}{s}_{1 , 1} , & {s}_{1 , 2} , & … , & {s}_{1 , B} \\ {s}_{2 , 1} , & {s}_{2 , 2} , & … , & {s}_{2 , B} \\ ⋮ & ⋮ & ⋱ & ⋮ \\ {s}_{K , 1} , & {s}_{K , 2} , & … , & {s}_{K , B}\end{matrix} ]$$

where x′, y′, and z′ are the coordinate variables of the target location, o is an orientation with East, South, West, and North at the target location, s_{i,b} is a measured received signal strength from an ith access point and a bth band at the target location.

The orientation o may be obtained from one or more orientation sensors in the mobile or asset.

Selecting the one or more fingerprints from the Wi-Fi multi-band fingerprint database in dependence on the selected most probable frequency band and selecting the measured signal may further comprise: a) generating a best frequency band set b=(b₁,b₂, . . . , b_{K})^{T} for each of K access points, wherein bᵢ is the most probable frequency band of an ith Wi-Fi access point; and b) selecting a fingerprint set (x, y, z, o)ₗ, (R̅S̅S̅_{1,b}_{₁}, R̅S̅S̅_{2,b}_{₂}, . . . , R̅S̅S̅_{K,b}_{ₖ})ₗ^{T} in dependence on the best frequency band set, where x, y, and z are three-dimension location coordinates, and o is an orientation with East, South, West, and North at an Ith defined reference point, and R̅S̅S̅_{1,b}_{ᵢ} is an average received signal strength from an ith access point at the selected most probable frequency band; and c) selecting the measured signal set (x′, y′, z′, o), (s_{1,}_{₁},s_{2,b}_{₂}, . . . , s_{K,b}_{_{K}})^{T} based on the frequency band set, where x′, y′, and z′ are the coordinates of target location, o is the orientation with East, South, West, and North at the target location, and s_{1,b}_{ᵢ} is the measured received signal strength from the ith Wi-Fi access point and a bth most probable frequency band at the target location.

The said location estimation algorithm may be a nearest neighbour with closest distance between the selected fingerprint set and the selected given signal set.

According to a second aspect of the present invention there is provided a method for positioning indoor location in a radio frequency transmission and receive system, which comprising: a) generating a Wi-Fi multi-band fingerprint database; b) selecting the most probable frequency band from the said multi-band for each WiFi access point; c) selecting the fingerprint database and the given signal that need to position the location on the said most probable frequency band for each WiFi access point; and d) comparing the selected given signal and the selected fingerprint database to position the location of the given signal by using a location estimation algorithm.

Generating the WiFi multi-band fingerprint database may further comprise: a) defining the reference points with known location in the indoor area; b) getting the received signal strengths of all the detected WiFi signals from different access points at all defined reference points; and c) storing the received signal strengths and corresponding location information of all access points at all reference points as the fingerprint database. Getting the received signal strengths may further comprise: measuring the received signal strengths of all the detected WiFi signals from different access points at all defined reference points. Getting the received signal strengths may further comprise: modelling the indoor scenario and network, and simulating the received signal strengths from different access points at all defined reference points.

The WiFi multi-band fingerprint database may further include the location information, average received signal strength and variance of received signal strength, the fingerprint at /th reference point may be

$${( x , y , z , o )}_{l} , {[ \begin{matrix}{\overline{RSS}}_{1 , 1} , & {\overline{RSS}}_{1 , 2} , & … , & {\overline{RSS}}_{1 , B} \\ {\overline{RSS}}_{2 , 1} , & {\overline{RSS}}_{2 , 2} , & … , & {\overline{RSS}}_{2 , B} \\ ⋮ & ⋮ & ⋱ & ⋮ \\ {\overline{RSS}}_{K , 1} , & {\overline{RSS}}_{K , 2} , & … , & {\overline{RSS}}_{K , B}\end{matrix} ]}_{l} , \\ {[ \begin{matrix}{σ}_{1 , 1} , & {σ}_{1 , 2} , & … , & {σ}_{1 , B} \\ {σ}_{2 , 1} , & {σ}_{2 , 2} , & … , & {σ}_{2 , B} \\ ⋮ & ⋮ & ⋱ & ⋮ \\ {σ}_{K , 1} , & {σ}_{K , 2} , & … , & {σ}_{K , B}\end{matrix} ]}_{l}$$

where x, y, and z may be the three-dimension location coordinate at /th reference point, and o may be the orientation with East (E), South (S), West (W), and North (N) at /th reference point, R̅S̅S̅_{i,b} may be average received signal strength from ith access point and bth band at /th reference point, and σ_{i,b} may be variance of received signal strength from ith access point and bth band at /th reference point. The said average received signal strength may be the mean value of all received signal strengths per access point per band at one reference point during a sampling period, and the variance may be the variance value of all received signal strengths per access point per band at one reference point during a sampling period.

The said most probable frequency band may be selected by a multi-band diversity combining method which comprises: a) getting the probability function P(s_{i,b}|l) that signal s_{i,b} appear given location/based on the said multi-band fingerprint database in the training phase, wherein s_{i,b} may be the measured received signal strengths from ith WiFi access point and bth frequency band at the given location /; b) calculating the probability function P(l|s_{ib}) at the target location / based on the given signals s_{i,b}; and c) finding the best frequency band with

$$arg {max}_{b} P ( l \vert {s}_{i , b} )$$

for each access point. The probability function P(s_{i,b}|l) may be calculated by: a) surveying the received signal strength multiple times at each survey location, and getting a statistically significant number of occurrences of every possible signal; and b) approximating by the maximum likelihood methods. The said maximum likelihood may be modelled by the parametric distributions.

The given signal may further comprise: a) measuring the multi-band received signal strengths at a target location from each access point; and b) reporting the multi-band measured received signal strengths of all access points to the server. The reported multi-band measured received signal strengths of all access points may be

$$( {x}^{′} , {y}^{′} , {z}^{′} , o ) , [ \begin{matrix}{s}_{1 , 1} , & {s}_{1 , 2} , & … , & {s}_{1 , B} \\ {s}_{2 , 1} , & {s}_{2 , 2} , & … , & {s}_{2 , B} \\ ⋮ & ⋮ & ⋱ & ⋮ \\ {s}_{K , 1} , & {s}_{K , 2} , & … , & {s}_{K , B}\end{matrix} ]$$

where x′, y′, and z′ may be the coordinate variables of target location, o may be the orientation with East (E), South (S), West (W), and North (N) at the target location, s_{i,b} may be measured received signal strength from ith access point and bth band at the target location. The orientation information o may be obtained from the orientation sensors in the mobile or asset.

Selecting the fingerprint database and given signal may further comprise: a) generating the best frequency band set b=(b₁, b₂, . . . , b_{K})^{T} for all K access points, wherein bᵢ may be the most probable frequency band of the ith WiFi access point; and b) selecting the fingerprint set (x, y, z, o)ₗ, (R̅S̅S̅_{1,b}_{₁}, R̅S̅S̅_{2,b}_{₂}, . . . , R̅S̅S̅_{K,b}_{_{K}})ₗ^{T} based on the best frequency band set, where x, y, and z may be the three-dimension location coordinate, and o may be the orientation with East (E), South (S), West (W), and North (N) at the /th defined reference point, and R̅S̅S̅_{1,b}_{ᵢ} may be average received signal strength from ith access point at the selected most probable frequency band; and c) selecting the given signal set (x′,y′,z′,o),(s_{1,b}_{₁},s_{2,b}_{₂}, . . . ,s_{K,b}_{_{K}})^{T} based on the frequency band set, where x′, y′, and z′ may be the coordinate of target location, o may be the orientation with East (E), South (S), West (W), and North (N) at the target location, and s_{i,b}_{ᵢ} may be the measured received signal strength from the ith WiFi access point and the bth most probable frequency band at the target location.

The said location estimation algorithm may be nearest neighbour with closest distance between the selected fingerprint set and the selected given signal set.

In order to overcome these shortcomings and deficiencies of the prior art, an object of the present invention to provide a method for indoor location based on fingerprint WiFi system with multi-band diversity combining, reducing the variation in received signal strength values, and as a result, improved the positioning accuracy.

Current WiFi APs can transmit with dual band or multi-band simultaneously, i.e. 2.4 GHz, and 5 GHz, and the receiver can simultaneously receive the dual band or multi-band RSS. The multi-RSS signals have the independent propagation loss, fading and shadowing etc due to different frequency transmission band, so diversity can be used to combat the fading to improve the location accuracy. A new metric is introduced for selection combining and shown to reduce variance in signal strength when used with frequency diversity. The combination of frequency diversity with selection combining is shown to enhance the location accuracy of objects or assets.

The technical aspect of the present invention is used is: a WiFi indoor positioning method based on fingerprints with multi-band diversity combining, which consists of: training and online positioning stages, the key steps may include:

Step 1: In the training phase, define the RPs for the indoor area, and a number of RSS are measured or simulated during a period of time for each location RP, where multi-band RSS from multiple APs are stored in the database as the location fingerprint, respectively.

Step 2: In the online positioning phase, receiver measures the real-time multi-band RSS at its position, and finish the multi-band measurement vectors.

Step 3: Assume the indoor propagation follows a probability distribution model and results in a probability distribution of received signal strength at each location for each AP. Based on the multi-band RSS at each location, finding the best signal transmission frequency band with maximum likelihood by probabilistic algorithm.

Step 4: Selecting the fingerprint and measurement signal based on the best band for target location.

Step 5: Comparing the selected measurement RSS with the selected RSS fingerprint which were built in the previous phase based on the selected frequency. The location can be estimated.

### BRIEF DESCRIPTION OF THE DRAWINGS

The present invention will now be described by way of example with reference to the accompanying drawings. In the drawings:

FIG. 1 shows the traditional fingerprint-based indoor localization method

FIG. 2 shows a block diagram of a method for positioning indoor location based on multi-band diversity fingerprint.

FIG. 3 shows a block diagram of an example of the inventive method.

FIG. 4 shows a flow chart of a selection diversity combining algorithm.

### DETAILED DESCRIPTION OF THE INVENTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Hereinafter, the present invention will be further described in detail with reference to the accompanying drawings. The invention is described in connection with wireless communications and more particularly relates to indoor positioning method based on fingerprint WiFi system with multi-band diversity combining, but the invention is not limited to any embodiment. The scope of the invention is limited only by the claims and the invention encompasses numerous alternatives, modifications and equivalents.

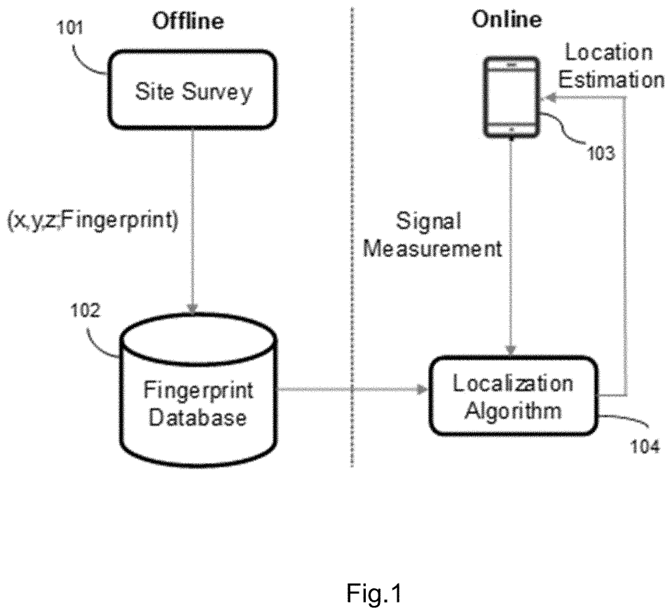

Traditional Wi-Fi fingerprinting is usually conducted in two phases: an offline phase followed by an online phase, as shown in Fig.1. In the offline phase, a site survey 101 is conducted to collect the vectors of received signal strength indicator (RSSI) of all the detected Wi-Fi signals from different access points (APs) at many reference points (RPs) of known locations. Hence, all the RSSI vectors form the fingerprints of the site and are stored at a database 102. In the online phase, a user (or target) 103 samples or measures an RSSI vector at the position and reports it to the server 104, the server compares the received target vector with the stored fingerprints. The target position is estimated based on the most similar “neighbours”, the set of RPs whose fingerprints closely match the target's RSSI.

A major challenge facing WiFi fingerprint location determination is that signal strength of received radio signals is a dynamic parameter and varies widely with changes in the environment due to fading, shadowing, barrier in the building etc. Such variation puts a limit on the resolution achievable by the location determination system.

Diversity has been a well-researched topic in the field of communications with the view of combating fading. It involves combing multiple uncorrelated signal envelopes in order to effectively reduce the variation in received signal strength values and as a result, improve accuracy is achieved in location determination.

Motivation for use of diversity techniques stems from the fact that the probability of simultaneous deep fading occurring on two or multiple uncorrelated fading channels is much lower than the probability of a deep fading occurring on a single branch system. Thus, employing a new selection combining approach on top of any diversity technique which assures sufficiently uncorrelated frequency channels will reduce the variance in signal strength. The rational for considering this variable is two-fold: (i) as received signal strength is inherently time varying, the signals that vary less would more likely result in better accuracy of localization; (ii) RSS variance is the most influential factor determining the accuracy of a WiFi fingerprinting system.

Current in a typical environment today with APs transmitter is dual band of WLAN (Wireless Local Area Network), i.e. 2.4 GHz and 5 GHz are simultaneously transmitted, and receivers can support both 2.4 GHz and 5 GHz bands to collect multiple samples for each measurement location. Therefore, from a WiFi fingerprinting system perspective, a measurement sample (WiFi scan) obtained either during the radio map construction phase or subsequent runtime positioning phase will likely include a mix signals of 2.4 GHz and 5 GHz channels. From the propagation characteristic, 2.4 GHz channel has low propagation loss, and result in high received signal strength, but the strong interference will result in the RSS fluctuation, and then high variance of RSS. 5 GHz channel has high propagation effect, but is less crowded and low interference due to more available spectrum. This in turn could impact the accuracy of the WiFi fingerprinting system as signals from these two bands behave differently.

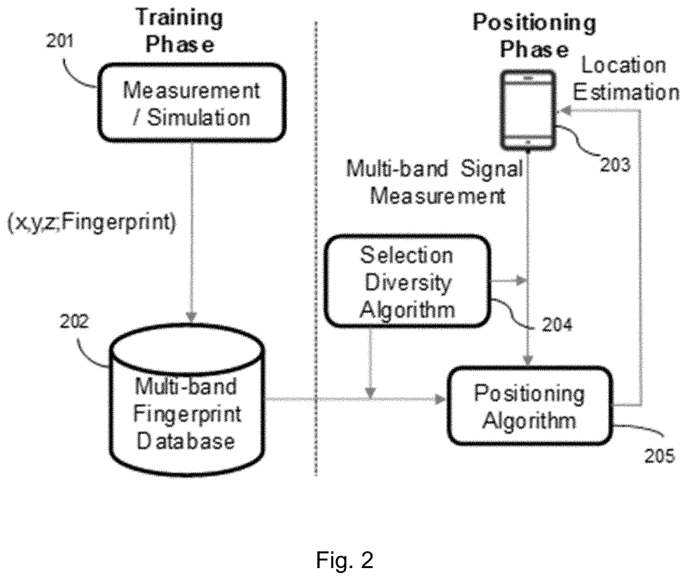

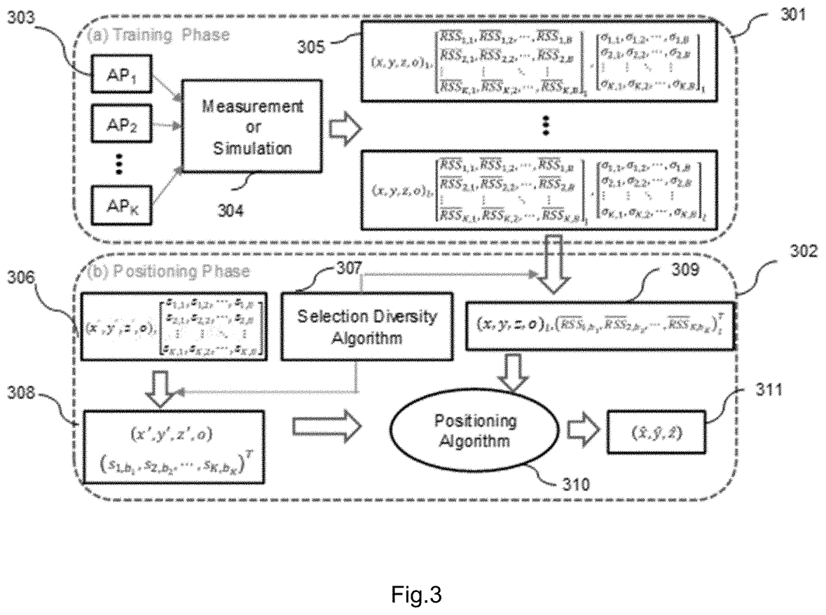

This invention uses the selection diversity combining over the multiple uncorrelated frequency channels results in reduced variance in signal strength, and then the location accuracy based on fingerprint can be improved. The fingerprint consisted of two phases, which are training and positioning phases, as shown in FIG. 2. In training phases, the multi-band RSS at each position from measurement or simulation 201 are used to create a multi-band fingerprint database 202, and the created database is used as reference for the localization 203 by positioning algorithm 205 in positioning phase based on the selection combining of multi-band RSS 204. The detail description is shown in FIG. 3.

The invention discloses an indoor positioning method based on fingerprint Wi-Fi system with multi-band diversity combining. The indoor positioning method includes the step of creating a position fingerprint database with multi-band RSS, a selection combining method based on probability density function of WiFi multi-band RSS is used for selecting the minimum variance signal of fingerprints and measured RSS. The closest distance among the position fingerprints and given RSS is comprehensively considered on the basis of the level of similarity to finish position estimation.

A. Training phase 301

Initially, without loss the generation, assuming all APs 303 transmit the multi-band signals, and the RSS of each band is pre-measured or simulated 304 to create the fingerprint database 305 based on pre-defined reference points (RPs). First, rasterize a known area into many RPs, a number of RSSs are measured or simulated during a period of time for each RP. At the same time, these values are stored as a signal strength distribution with probability density function (PDF).

Assuming there are B frequency bands for each AP, and the RSS from ith AP at a RP can be described

mᵢ=[R̅S̅S̅_{i,1},R̅S̅S̅_{i,2}, . . . , R̅S̅S̅_{i,B}]

where R̅S̅S̅_{i,b} is the average RSS in a measured period on bth band from ith AP. The fingerprint and their location information 1 are usually denoted as a tuple of (l,m). If orientation of mobile or asset is considered at the RP, then the location information is denoted as

l={(x,y,z,o)|x,y,z ∈ R, o ∈{E,S,W,N}}

where x, y, and z are the three-dimension location coordinate, and o is the orientation with East (E), South (S), West (W), and North (N). For each frequency band of each AP, there have T RSS values based on a specific sample time, i.e.

RSS_{i,b}=[RSS_{i,b}(1),RSS_{i,b}(2), . . . , RSS_{i,b}(T)]

Assuming the probability density function (PDF) on bth band from ith AP at /th RP is f_{i,b,l}, which can follow a Rayleigh distribution, and the mean and variance on the specific sample time are R̅S̅S̅_{i,b} and σ_{i,b}, the PDF can be denoted as

$${f}_{i , b , l} ( s ) = \frac{s}{{σ}_{i , b , l}^{2}} {e}^{\frac{- {s}^{2}}{2 {σ}_{i , b , l}^{2}}}$$

Simply, there are a total of T RSS values based on a specific sample time at the RP, RSS_{i,b}=[RSS_{i,b}(1),RSS_{i,b}(2), . . . , RSS_{i,b}(T)], the probability P(RSS_{i,b}|l) that signal RSS_{i,b} appear the given location RP can be calculated as

$$P ( {RSS}_{i , b} \vert l ) = \frac{count ( {AP}_{i , l , b} = {RSS}_{i , b} )}{T}$$

where AP_{i,l,b} denotes the received signal on bth frequency band from ith AP at /th RP. If K APs are selected to create the fingerprint at the RP, the fingerprint database 305 at RP / is described as

$${( x , y , z , o )}_{l} , {[ \begin{matrix}{\overline{RSS}}_{1 , 1} , & {\overline{RSS}}_{1 , 2} , & … , & {\overline{RSS} }_{1 , B} \\ {\overline{RSS}}_{2 , 1} , & {\overline{RSS}}_{2 , 2} , & … , & {\overline{RSS} }_{2 , B} \\ ⋮ & ⋮ & ⋱ & ⋮ \\ {\overline{RSS}}_{K , 1} , & {\overline{RSS}}_{K , 2} , & … , & {\overline{RSS} }_{K , B}\end{matrix} ]}_{l} , \\ {[ \begin{matrix}{σ}_{1 , 1} , & {σ}_{1 , 2} , & … , & {σ }_{1 , B} \\ {σ}_{2 , 1} , & {σ}_{2 , 2} , & … , & {σ }_{2 , B} \\ ⋮ & ⋮ & ⋱ & ⋮ \\ {σ}_{K , 1} , & {σ}_{K , 2} , & … , & {σ }_{K , B}\end{matrix} ]}_{l}$$

B. Positioning phase 302

In the positioning phase 302, the measured RSS at the receiver at a target location is matched with fingerprint database which was built in the previous phase. Because the multi-band RSSs are received at each target location, the selection combining algorithm can be used to select the best frequency band RSS based on the PDF to match the fingerprint, so the diversity gain can improve the positioning accuracy.

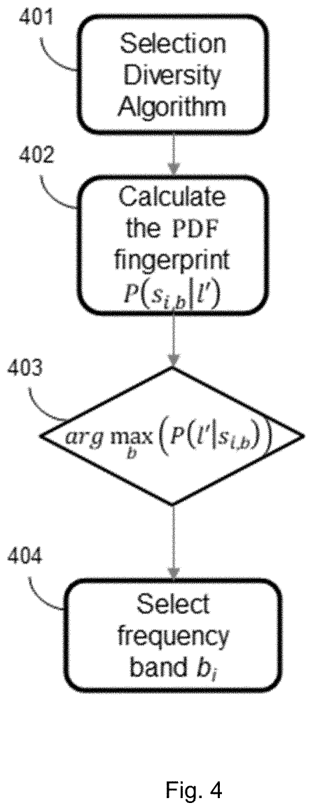

Assuming the mobile or asset is at the target location l′, the measured RSS at the l′ is s_{i,b} on the bth frequency band from the ith AP, so the measured signal 306 at the target location l′ can be written as

$$( {x}^{′} , {y}^{′} , {z}^{′} , o ) , [ \begin{matrix}{s}_{1 , 1} , & {s}_{1 , 2} , & … , & {s }_{1 , B} \\ {s}_{2 , 1} , & {s}_{2 , 2} , & … , & {s }_{2 , B} \\ ⋮ & ⋮ & ⋱ & ⋮ \\ {s}_{K , 1} , & {s}_{K , 2} , & … , & {s }_{K , B}\end{matrix} ]$$

where x′, y′, and z′ are the coordinate of target location l′, which need to be estimated based on the positioning algorithm. By selection diversity algorithm 401, as shown in FIG. 4, the most proper frequency band is selected to estimate the target location l′(x′, y′, z′). Define P(l′|s_{i,b}) as the probability of the target location l′(x′, y′, z′) given measured signals s_{i,b}. Apply Bayes' theorem.

$$P ( {l}^{′} \vert {s}_{i , b} ) = \frac{P ( {s}_{i , b} \vert {l}^{′} ) P ( {l}^{′} )}{P ( {s}_{i , b} )}$$

where P(l′) is the probability that the mobile or asset is at the location l′, P(s_{i,b}) is the RSS probability, and P(s_{i,b}|l′) is the probability 402 that signal s_{i,b} appear the given location l′, which can be calculated by the PDF f_{i,b,l}(s), i.e.

$$P ( {s}_{i , b} \vert {l}^{′} ) = {\int }_{{AP}_{i , {l}^{′} , b = {s}_{i , b}}}^{∞} {f}_{i , b , l} ( s ) ds$$

where AP_{i,l′,b} denotes the received signal on bth frequency band from ith AP at the target location. Or calculating the probability based on the above probability P(RSS_{i,b}|l′), i.e.

$$P ( {s}_{i , b} \vert {l}^{′} ) = \frac{count ( {AP}_{i , {l}^{′} , b} = {s}_{i , b} )}{T}$$

Because the system only cares about the most probable frequency band 403, that location factor is just a constant that can ignore, the most probable frequency band 404 can be found

$$arg {max}_{b} P ( {l}^{′} \vert {s}_{i , b} ) = arg {max}_{b} P ( {s}_{i , b} \vert {l}^{′} ) / P ( {s}_{i , b} )$$

The Wi-Fi multi-band fingerprint database includes multiple frequency band fingerprints at each location. Once the most probable frequency band is selected, the fingerprints of the corresponding frequency band from multiple band fingerprint database may be selected, forming a single frequency band fingerprint database.

By application of the selection combining approach 307 where the measured RSS of frequency band with maximum probability of above expression is selected, i.e.

b=(b₁,b₂, . . . , b_{K})^{T}

where (.)^{T} denotes the transposition of vector, and bᵢ is the selected frequency band of ith AP. So the measured RSS 309 from K APs can be described as

s=(s_{1,b}_{₁},s_{2,b}_{₂}, . . . , s_{K,b}_{_{K}})^{T}

The corresponding selected fingerprint 308 in the database at location / can be expressed as

mₗ=(R̅S̅S̅_{1,b}_{₁},R̅S̅S̅_{2,b}_{₂}, . . . , R̅S̅S̅_{K,b}_{_{K}})ₗ^{T}

where R̅S̅S̅_{1,b}, is average RSS from ith AP at the selected most probable frequency band. In the positioning calculation 310, deterministic type of algorithm based on nearest neighbour (NN) classifiers can be used to position the location. The basic algorithm concept of NN is closest distance algorithm, that the selected measured RSS is matched to the closest selected fingerprint value to estimate the position.

The closest distance of signal space is denoted as Dist(.) function, which can be the Euclidean distance, or Manhattan distance, etc. Therefore, calculate the closest distance between the target point location and fingerprint reference point location 311 as follows:

$$( \hat{x} , \hat{y} , \hat{z} ) = arg {min}_{l} Dist ( {m}_{l} , s )$$

where \hat{x},ŷ, and z̅ are the estimated coordinate of location l′(x′, y′, z′).

For the Euclidean distance method, the expression is

$$( \hat{x} , \hat{y} , \hat{z} ) = arg {min}_{l} \sqrt{{\sum }_{i = 1}^{K} {( {m}_{l , i} - {s}_{i} )}^{2}}$$

For the Manhattan distance method, the expression is

$$( \hat{x} , \hat{y} , \hat{z} ) = arg {min}_{l} {\sum }_{i = 1}^{K} \vert {m}_{l , i} - {s}_{i} \vert$$

Indoor location based Wi-Fi location fingerprinting of the present invention not only considers the closest distance between the position of fingerprints, but also considers the frequency diversity between multi-bands, and improve the accuracy of positioning accuracy. When building location fingerprint database only stores the received signal strength average value data, also stores the received signal strength standard variance of the data to calculate the signal distribution.

A detailed description of the preferred embodiment of the present invention specific or more. It should be understood that one of ordinary skill in the art without creative work to many modifications and variations may be made according to the teachings of the present invention. Therefore, all those skilled in the art under this inventive concept on the basis of prior art technical solutions through logical analysis, reasoning or limited experiments could be obtained, are to be made within the scope of the claims determined.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for determining the position of a mobile or asset in an indoor location in a radio frequency transmission and receive system, the method comprising:
a) generating a Wi-Fi multi-band fingerprint database using at least one multi-band Wi-Fi access point configured to simultaneously transmit multiple frequency band wireless signals;
b) selecting, from the multiple frequency band wireless signals transmitted by each Wi-Fi access point, a most probable frequency band having the highest probability function for a target location of the mobile or asset given one or more measured signals;
c) selecting one or more fingerprints from the Wi-Fi multi-band fingerprint database in dependence on the selected most probable frequency band and selecting a measured signal that is needed to determine the location in dependence on the said most probable frequency band for each Wi-Fi access point; and
d) comparing the selected measured signal and the selected one or more fingerprints to determine the location of the measured signal in dependence on a location estimation algorithm.

2. The method as claimed in claim 1, wherein generating the Wi-Fi multi-band fingerprint database comprises:
a) defining a plurality of reference points having known locations in an indoor area;
b) getting a plurality of received signal strengths for a plurality of detected Wi-Fi signals from a plurality of access points at the respective defined reference points; and
c) storing the plurality of received signal strengths and corresponding location information of the respective access points at the respective reference points as the Wi-Fi multi-band fingerprint database.

3. The method as claimed in claim 2, wherein getting the plurality of received signal strengths comprises:
measuring the plurality of received signal strengths for the plurality of detected Wi-Fi signals from the plurality of access points at the respective defined reference points.

4. The method as claimed in claim 2 or 3, wherein getting the plurality of received signal strengths comprises:
modelling an indoor scenario and network; and
simulating the plurality of received signal strengths from the plurality of access points at the respective defined reference points.

5. The method as claimed in any preceding claim, wherein the Wi-Fi multi-band fingerprint database further comprises location information, average received signal strength and variance of received signal strength, a fingerprint at /th reference point being represented by
$${( x , y , z , o )}_{l} , {[ \begin{matrix}{\overline{RSS}}_{1 , 1} , & {\overline{RSS}}_{1 , 2} , & … , & {\overline{RSS} }_{1 , B} \\ {\overline{RSS}}_{2 , 1} , & {\overline{RSS}}_{2 , 2} , & … , & {\overline{RSS} }_{2 , B} \\ ⋮ & ⋮ & ⋱ & ⋮ \\ {\overline{RSS}}_{K , 1} , & {\overline{RSS}}_{K , 2} , & … , & {\overline{RSS} }_{K , B}\end{matrix} ]}_{l} , \\ {[ \begin{matrix}{σ}_{1 , 1} , & {σ}_{1 , 2} , & … , & {σ }_{1 , B} \\ {σ}_{2 , 1} , & {σ}_{2 , 2} , & … , & {σ }_{2 , B} \\ ⋮ & ⋮ & ⋱ & ⋮ \\ {σ}_{K , 1} , & {σ}_{K , 2} , & … , & {σ }_{K , B}\end{matrix} ]}_{l}$$
where x, y, and z are three-dimension location coordinates at an /th reference point, and o is an orientation with East, South, West, and North at the /th reference point, R̅S̅S̅_{i,b} is an average received signal strength from an ith access point and a bth band at the /th reference point, and σ_{i,b} is a variance of received signal strength from the ith access point and a bth band at the /th reference point.

6. The method as claimed in claim 5, wherein the said average received signal strength is the mean value of the plurality of received signal strengths per access point per band at one reference point during a sampling period, and the variance is the variance value of all received signal strengths per access point per band at one reference point during a sampling period.

7. The method as claimed in any preceding claim, wherein the said most probable frequency band is selected by a multi-band diversity combining method which com prises:
a) getting a probability function, P(s_{i,b}|l), that a signal s_{i,b} is received at a given location / in dependence on the said multi-band fingerprint database, wherein s_{i,b} is the measured received signal strengths from an ith Wi-Fi access point and a bth frequency band at the given location l;
b) calculating the probability function P(l|s_{i,b}) at the target location / based on the given signals s_{i,b}; and
c) finding the frequency band with the highest probability function,
$$arg {max}_{b} P ( l \vert {s}_{i , b} ) ,$$
for each access point.

8. The method as claimed in claim 7, wherein the probability function P(s_{i,b}|l) is calculated by:
a) surveying received signal strength multiple times at each of at least one survey location, and getting a statistically significant number of occurrences of each possible signal; and
b) approximating the probability function P(s_{i,b}|l) by maximum likelihood methods.

9. The method as claimed in claim 8, wherein the said maximum likelihood is modelled by parametric distributions.

10. The method as claimed in any preceding claim, wherein selecting the measured signal further comprises:
a) measuring multi-band received signal strengths at the target location from each access point; and
b) reporting the multi-band measured received signal strengths of each access point to a server.

11. The method as claimed in claim 10, wherein the reported multi-band measured received signal strengths for each access point are represented by
$$( {x}^{′} , {y}^{′} , {z}^{′} , o ) , [ \begin{matrix}{s}_{1 , 1} , & {s}_{1 , 2} , & … , & {s }_{1 , B} \\ {s}_{2 , 1} , & {s}_{2 , 2} , & … , & {s }_{2 , B} \\ ⋮ & ⋮ & ⋱ & ⋮ \\ {s}_{K , 1} , & {s}_{K , 2} , & … , & {s }_{K , B}\end{matrix} ]$$
where x′, y′, and z′ are the coordinate variables of the target location, o is an orientation with East, South, West, and North at the target location, s_{i,b} is a measured received signal strength from an ith access point and a bth band at the target location.

12. The method as claimed in claim 11, wherein the orientation o is obtained from one or more orientation sensors in the mobile or asset.

13. The method as claimed in any preceding claim, wherein selecting the one or more fingerprints from the Wi-Fi multi-band fingerprint database in dependence on the selected most probable frequency band and selecting the measured signal further com prises:
a) generating a best frequency band set b=(b₁,b₂, . . . , b_{K})^{T} for each of K access points, wherein bᵢ is the most probable frequency band of an ith Wi-Fi access point; and
b) selecting a fingerprint set (x, y, z, o)ₗ, (R̅S̅S̅_{1,b}_{₁}, R̅S̅S̅_{2,b}_{₂}, . . . , R̅S̅S̅_{K,b}_{_{K}})ₗ^{T} in dependence on the best frequency band set, where x, y, and z are three-dimension location coordinates, and o is an orientation with East, South, West, and North at an lth defined reference point, and R̅S̅S̅_{1,b}_{ᵢ} is an average received signal strength from an ith access point at the selected most probable frequency band; and
c) selecting the measured signal set (x′, y′, z′, o), (s_{1,b}_{₁}, s_{2,b}_{₂}, . . . , s_{K,b}_{_{K}})^{T} based on the frequency band set, where x , y , and z are the coordinates of target location, o is the orientation with East, South, West, and North at the target location, and s_{1,b}_{ᵢ} is the measured received signal strength from the ith Wi-Fi access point and a bth most probable frequency band at the target location.

14. The method as claimed in any preceding claim, wherein the said location estimation algorithm is a nearest neighbour with closest distance between the selected fingerprint set and the selected given signal set.
